(19) United States
(12) Patent Application Publication
(10) Pub. No.: US 2002/0136896 A1
(43) Pub. Date: Sep. 26, 2002

(54) Method of preparing electron emission source and electron emission source

(75) Inventors: Hirofumi Takikawa, Toyohashi-shi (JP); Shigeo Itoh, Mobara-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: FUTABA DENSHI KOGYO KABUSHIKI KAISHA, Mobara-shi (JP)

(21) Appl. No.: 10/138,570

(22) Filed: May 6, 2002

Related U.S. Application Data
(62) Division of application No. 09/532,862, filed on Mar. 22, 2000, now abandoned.

(30) Foreign Application Priority Data
Mar. 23, 1999 (JP) 11-118462

(51) Int. Cl. B05D 5/12; H05H 1/24

(52) U.S. Cl. 428/408; 427/77; 427/569; 427/78

(57) ABSTRACT

A method of preparing an electron emission source having excellent electron emission characteristics which is easily produced and an electron emission source are provided. Chamber 101 is brought to He atmosphere of 1 Pa pressure, arc current of DC 100 A is allowed to flow to perform arc discharge for one second, cathode 102 is heated locally, cathode materials constituting cathode 102 are scattered and carbon particles on the surface of which a lot of carbon nano-tube is formed are produced. The aforementioned carbon particles are collected to use as an emitter of an electron emission source.

### BACKGROUND OF THE INVENTION

1. Field of the Invention

This invention relates to an electron emission source and an electron emission source prepared thereby.

2. Description of the Prior Art

A field (electron) emission source is superior to an electron source (thermionic emission source) making use of thermal energy in energy saving and possibility of increasing its life and so on. As a material for a field emission source currently used is known a semiconductor such as silicon (Si) and the like, a metal such as tungsten (W), molybdenum (Mo) and so on, Diamond-Like Carbon (DLC) and so on.

In a field emission phenomenon, when approximately 10⁹V/m is applied to the surfaces of metal or semiconductor, electrons pass through a barrier by tunnel effect to be emitted into vacuum even at normal temperatures. Therefore, its output current is determined depending on whether or not how high electric field is applied to an emission region (hereinafter referred to as emitter) from an output electrode section (hereinafter referred to as gate electrode). Accordingly, it has been known that the sharper the tip of the emitter is, the higher the electric field strength applied to the emitter is. It is, therefore, required to work the tip of the electron emission region of the aforementioned semiconductor or metal in the shape of sharp needle.

It has been also required to maintain an operating atmosphere in high vacuum of 10⁻⁸ Torr and above in order to stabilize the filed emission. From this point of view, a carbon nano-tube has been currently receiving considerable attention as a material for a field emission source. Since the carbon nano-tube has a structural form sufficient to perform the field emission at a low voltage, that is, 10 to several 10 nm in outer diameter and several μm in length and carbon as its material is characterized by chemical stability and mechanical strength, it is an ideal material for the field emission source.

As a conventional method of preparing a carbon nano-tube there is a method of preparing carbon deposits containing carbon nano-tube at a carbon electrode as a cathode by carbon direct current (DC) arc discharge in an atmosphere of gas of high pressure such as He of 200 Torr to 2,500 Torr and so on as described in Laid-Open Patent Publication No. 6-280116. The carbon nano-tubes are formed as integrated bundles in the core of the shell of amorphous carbon of the aforementioned carbon deposits, the core is usually dispersed by ultrasonic wave and the carbon nano-tube are extracted, classified and collected by means of a filter.

In the aforementioned conventional method of preparing a carbon nano-tube, since the carbon nano-tube is collected from the carbon deposits at the cathode by DC arc discharge, there have been problems that the collecting rate is extremely low and the method of preparing is complicated. Accordingly, the carbon nano-tube obtained by the aforementioned method is excessively high expensive and, therefore, there has been a problem that it is not profitable from cost efficiency to prepare the electron emission source by using thereof.

While an attempt has been made to prepare a paste of the carbon nano-tube which is printed and formed onto a given electrode as a process for mounting the conventional carbon nano-tube electron as a emission source, almost all of the printed carbon nano-tube fall along a substrate because of a viscosity of a solvent for the printing paste and additives. Therefore, no available field emission effect can be obtained and there have been problems that outputted voltage is high and outputted electric current is small.

### SUMMARY OF THE INVENTION

An object of this invention is to provide a method of preparing an electron emission source which can be easily prepared and is excellent in electron emission characteristics.

Another object of this invention is to provide an electron emission source which can be easily prepared and is excellent in electron emission characteristics and can be easily mounted onto a substrate.

According to this invention, a solid or powdered material comprising graphite or graphite containing a given catalyst metal is heated instantaneously at a high temperature in plasma in an atmosphere of gas of given pressures of 10 Torr to 10⁻⁶ Torr to decompose carbon to monatomic level and thereafter a carbon nano-tube, nano-capsule or fullerene is recrystallized around a crystal nucleus.

Accordingly, there is formed a carbonaceous substance containing the aforementioned carbon nano-tube, nano-capsule, fullerene or mixture thereof or a carbonaceous substance containing carbon fine particles the surface of which at least one of carbon nano-tube, nano-capsule and fullerene is grown. The aforementioned carbonaceous substance can be used as an electron emission material which emits electrons by the action of electric field.

According to this invention, there is provided a method of preparing an electron emission source characterized in that the aforementioned electron emission material obtained by the aforementioned manner is deposited onto a substrate comprising an insulator, a semiconductor or a metal to use as an emitter in a method of preparing an electron emission source comprising placing an electron emission material as an emitter between a plurality of electrodes and an electron emission source prepared by the method.

As an instantaneous heating method at high temperatures in an atmosphere of gas of a given pressure of 10 Torr to 10⁻⁶ Torr there are, for example, a vacuum arc discharge method, a vacuum thermal plasma method and a laser abrasion method, and there are resistance heating and lamp heating as auxiliary heating.

The vacuum arc discharge method herein used is that includes cathode arc and anode arc which can make use of direct current (DC), alternative current (AC), one-time pulse and repetitive pulse current types. The conventional arc discharge method has a thermally compressed positive column and an anode as well as a cathode are active on the surfaces of which electrode spots are provided.

On the contrary, the vacuum arc discharge method is a method said to be a diffusion discharge, and, in general, nothing but a cathode is active, and while a cathode spot is present, neither anode spot nor positive column is present. However, when the anode is considerably smaller than the cathode, the anode spot is formed to become an anode arc. On the contrary, in a cathode vacuum arc plasma method a solid or powdered material comprising graphite or graphite containing given catalyst metal is used as a cathode and an inner wall of a container surrounding it serves as an anode.

Accordingly, only a cathode spot is present and only a cathode material is evaporated to supply particles constituting plasma. And, carbon particles on the surface of which carbonaceous substance containing a lot of at least one of carbon nano-tube, nano-capsule and fullerene is grown can be prepared by compressing the cathode spot and arc plasma region by magnetic field to increase current density and to increase the temperature of the cathode spot in the aforementioned cathode vacuum arc plasma method.

And, in the arc plasma method, a direct current is applied continuously or intermittently or a method of applying pulse current is used, and gas or rare gas illustrated by CₓH_{y}O_{z}N_{w} (X, Y, Z, W≧0) family may be used as the aforementioned gas. And, Ni, Y, Fe, Co, Pt, Rh, W, V, Pd and mixture thereof may be used as a catalyst metal.

As a method of adding the catalyst metal into a material may be used mixing of the catalyst metal with solid or powdered material or embedding of solid catalyst metal into solid.

Further, the aforementioned substrate comprising an insulator, a semiconductor or a metallic body is placed in the vicinity of a material forming an electron emission source in such a manner as previously described and made to adhere directly to an electron emission material such as carbon nano-tube or carbon particles prepared to make it possible to form the aforementioned electron emission source.

It is also possible to improve the formation efficiency by applying DC bias or RF bias to the aforementioned substrate.

Furthermore, it is not objectionable that the aforementioned electron emission source is brought to a state of paste which is made to adhere to the aforementioned substrate by a method such as a printing method, an electrodeposition method, a slurry formation method, a doctor blade method, a sedimentation method, an ink-jet printing method and so on to form the aforementioned electron source layer on the aforementioned substrate, or the aforementioned electron emission source is made to adhere in a state of powder to the aforementioned substrate by electrostatic adsorption-adhesion to form the aforementioned electron source layer on the aforementioned substrate.

And the first electrode, an insulating layer, the second electrode and a lift-off layer are deposited on the aforementioned substrate in which a hollow is formed so as to expose the aforementioned first electrode, and the aforementioned lift-off layer is removed after formation of emitter by depositing the aforementioned electron emission material on the aforementioned substrate.

Alternatively, the first electrode, a resistance layer, an insulating layer, the second electrode and a lift-off layer are deposited on the aforementioned substrate in which a hollow is formed so as to expose the aforementioned resistance layer, and the aforementioned lift-off layer is removed after formation of emitter by depositing the aforementioned electron emission material on the aforementioned substrate. Electrons are emitted by field emission phenomenon from a tip of the carbon nano-tube, nano-capsule, and fullerene contained in the aforementioned electron emission material or a tip of the carbon nano-tube, nano-capsule, fullerene on the surface of the aforementioned carbon particles by applying a given electric voltage between the first electrode and the second electrode of the electron emission source thus prepared.

Further, when plasma is used, a radical molecule the molecular weight of which is lower than that obtained by thermal decomposition can be produced, thereby improving and controlling the reactivity.

### BRIEF DESCRIPTION OF THE DRAWINGS

For a more complete understanding of this invention may be had to the following detailed explanations in connection with the accompanying drawings, in which

FIG. 1 is a schematic representation of an apparatus used in a method of preparing an electron emission source of the first working embodiment of this invention.

FIG. 2 is a photograph of a scanning electron microscope showing a carbon particle produced by the first working embodiment of this invention.

FIG. 3 is a partial diagrammatic view of a photograph of a transmission electron microscope of a carbon particle produced by the first working embodiment of this invention.

FIG. 4 is a view showing an electron emission source of a working embodiment of this invention.

FIG. 5 is a schematic representation of an apparatus used in a method of preparing an electron emission source of the second working embodiment of this invention.

FIG. 6 is a photograph of a scanning electron microscope showing a substrate produced by the second working embodiment of this invention.

FIG. 7 is an enlarged photograph of a scanning electron microscope of a substrate produced by the second working embodiment of this invention.

FIG. 8 is a partial side sectional view showing a method of preparing an electron emission source of the second working embodiment of this invention.

FIG. 9 is a partial side sectional view showing a method of preparing an electron emission source of the third working embodiment of this invention.

### DETAILED DESCRIPTION OF THE PREFERRED EMBODIMENT

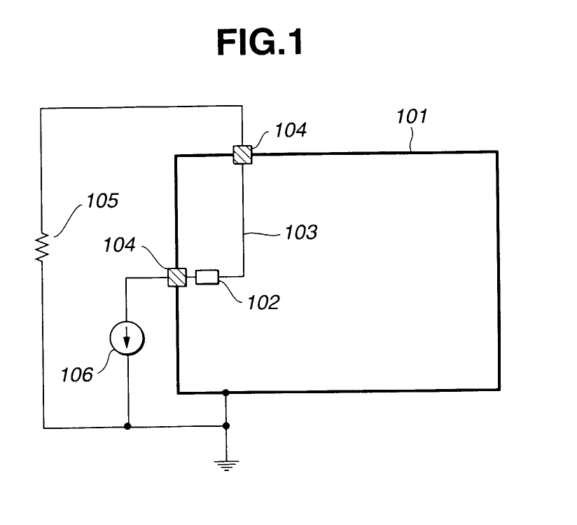

Referring now to FIGS. 1 to 9, preferred working examples of this invention are described.

FIG. 1 is a schematic representation of an apparatus used in a cathode vacuum arc plasma method used in a method of preparing an electron emission source of the first working embodiment of this invention.

In FIG. 1, cathode 102 and Mo-made trigger electrode 103 are placed in SUS 304-made chamber 101 functioning as an anode.

A various kinds of materials using graphite, for example, graphite (purity: 99. 998 wt %), Ni-Y-containing graphite (Ni:14. 6 wt %, Y: 4. 9 wt %), Y-containing graphite (Y: 0. 82 wt %), Fe-containing graphite (Fe: 3.0 wt %), or Co-containing graphite (Co: 3.0 wt %) may be available as a material for cathode 102 as a material for forming a substance containing the carbon nano-tube, nano-capsule, fullerene or mixture thereof or a carbonaceous substance containing particles (carbon particles) on the surface of which at least one of the carbon nano-tube, nano-capsule and fullerene is grown.

Protective resistance 105, ammeter 106 for detecting electric current flowing at the time of arc discharge and an electrode (not illustrated) for performing arc discharge are placed outside chamber 101 via insulating member 104.

Chamber 101 is brought in an atmosphere of He of 1 Pa pressure, arc discharge is performed for one second by flowing arc current of DC 100A to heat cathode 102 locally, a cathode material constituting cathode 102 is melted and scattered in arc plasma of high temperature to produce scattered droplets of fine carbon particles which are scattered and made to adhere to a substrate or chamber wall to form a thin film or a fine carbon particle layer.

Carbon aggregates which have been melted once are recrystallized on the surface of the aforementioned thin film or carbon particle layer when they are quenched and carbonaceous substances containing a lot of at least one of the carbon nano-tube, nano-tube and fullerene are grown around carbon or a chemical compound of carbon and catalyst metal as a nucleus on the surface of the aforementioned thin film or carbon particle layer.

And, a carbonaceous substance containing the carbon nano-tube, nano-capsule, fullerene or mixture thereof is also formed.

The aforementioned carbon particles can be applied to an electron emission source as an emitter having a function as an electron emission material for emitting electrons by an electric field by a method such as a method in which the aforementioned carbon particles made to adhere to chamber 101 are collected and made to adhere to a substrate for an electron emission source, or a method in which the substrate is placed in the direction of scattering of scattered droplets in chamber 101, to which the aforementioned carbon particles are directly made to adhere and so on. In the present trial manufacture, the aforementioned scattered droplets were emitted in quantity in the direction of a 30 · angle from a cathode face. It is, therefore, necessary to adjust the position and size of the substrate and uniformity of the film thickness to its emission distribution.

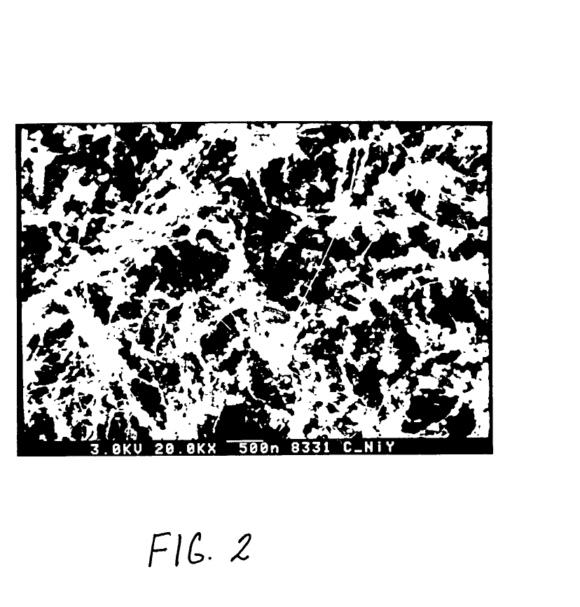

FIG. 2 is a photograph of the aforementioned carbon particles produced under the aforementioned conditions observed by a scanning electron microscope (SEM). The carbon nano-tube looks like a fine line. It is evident that the surface of the aforementioned carbon particles are covered with a lot of carbon nano-tube by the aforementioned methods.

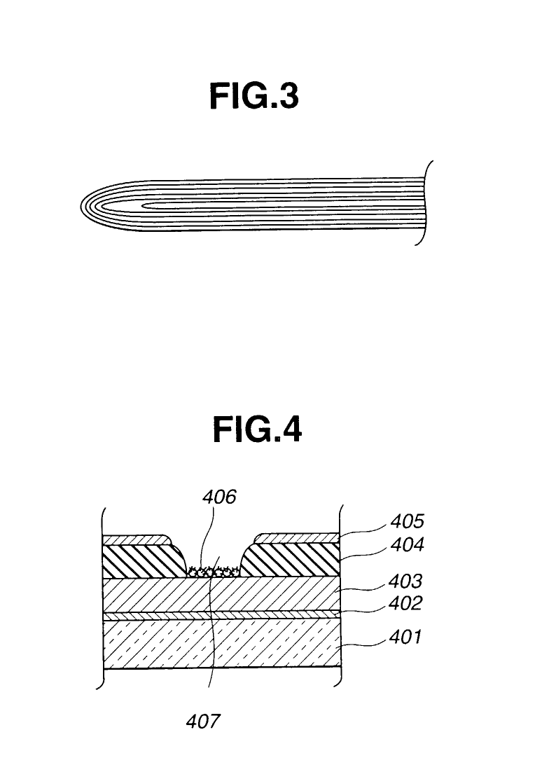

FIG. 3 is a partial diagrammatic view of a photograph of the aforementioned carbon particles collected from a chamber wall observed by a transmission electron microscope (TEM). It is evident that a multi-layer carbon nano-tube is produced.

FIG. 4 is a view showing an electron emission source of a working embodiment of this invention and is a fragmentary sectional view of an electron emission source making use of collected carbon particles produced by the aforementioned method as an electron emission material to an emitter. In FIG. 4, glass-made substrate 401, cathode electrode 402 as the first electrode, resistance layer 403, insulating layer 404 and gate electrode 405 as the second electrode are laminated to one another and hollow 407 is formed so as to expose resistance layer 403. The same structure is true for a case where substances containing carbon nano-tube, nano-capsule, fullerene or mixture thereof are collected, which are used to the emitter as the electron emission material.

As substrate 401 may be available a ceramic-made substrate, a semiconductive substrate, a plastic-made substrate and so on. And; forming conditions can be controlled by adding DC bias or RF (Radio Frequency) to substrate 401.

An emitter of a field emission source is formed onto resistance layer 403 in hollow 407 by a method in which an electron emission material containing the carbon nano-tube, nano-capsule, fullerene or mixture thereof obtained in such a manner as previously described or an electron emission material containing carbon particles 406 on the surface of which at least one of the carbon nano-tube, nano-capsule and fullerene is grown is brought to a state of paste which is made to adhere to resistance layer 403 by a method such as a thick film printing, an electrodeposition method, a slurry forming method, a doctor blade method, a sedimentation method or a powder coating method. When resistance layer 403 for prevention of emitter breakdown by excess current is not required, carbon particles 406 are applied and deposited directly on cathode electrode 402.

The electron emission source constituted in such a manner as described above emits electrons from the tip of a layer of carbon nano-tube, nano-capsule, fullerene or mixture thereof or the tip of carbon nano-tube, nano-capsule or fullerene on the surface of carbon particles 406 constituting the emitter by a field emission phenomenon by applying voltage between cathode electrode 402 and gate electrode 405. This can be used as a cathode of a field emission display or vacuum micro device.

While the present working embodiment is carried out by bring chamber 101 to He atmosphere of 1 Pa pressure, it can be carried out in rare gas such as O₂, H₂, N₂ or Ar in an atmosphere of from low vacuum of 10 Torr and below to medium and high vacuum of 10⁻³ to 10⁻⁶ Torr.

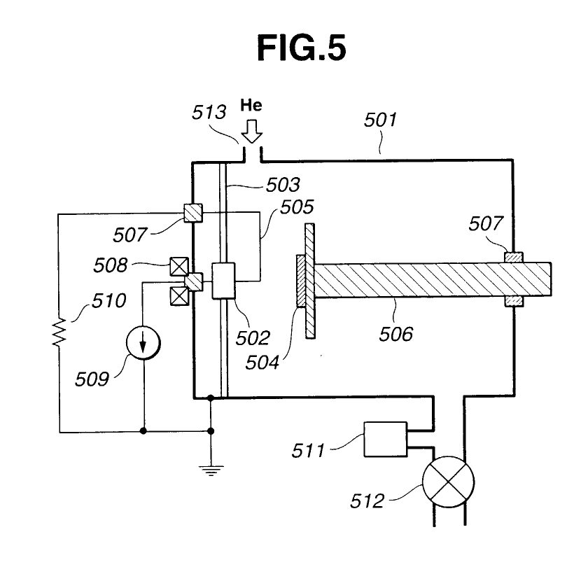

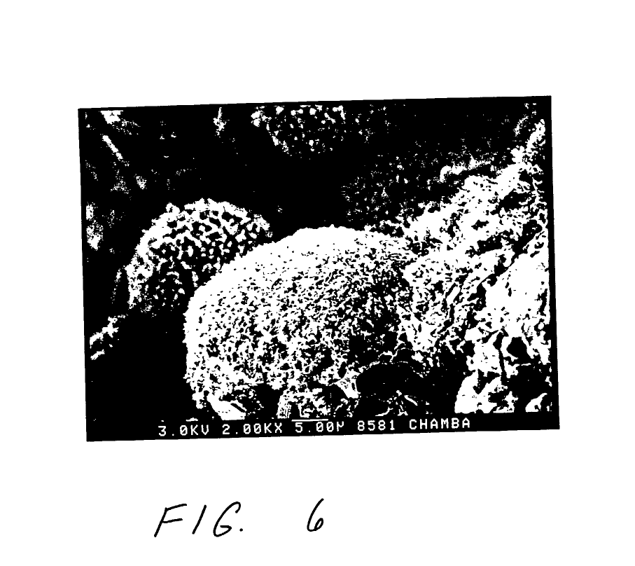

FIG. 5 is a schematic representation of an apparatus used in a method of preparing an electron emission source of the second working embodiment of this invention.

In FIG. 5, cathode 502, barrier plate 503, Mo-made trigger electrode 505 and substrate fixing block 506 are placed in SUS-made chamber 501 functioning as an anode. Substrate fixing block 506 is fixed to chamber 501 in a state of electrically floating by insulating member 507, and substrate 504 made of Si, Ni, Co or Fe is fixed to substrate fixing block 506. Substrate 504 is placed in the vicinity of cathode 502, for example, at a position approximately 85 mm away from the surface of cathode 502.

A various kinds of materials using graphite, for example, graphite (purity: 99. 998 wt %), Ni-Y-containing graphite (Ni: 14. 6 wt %, Y: 4. 9 wt %), Y-containing graphite (Y: 0. 82 wt %), Fe-containing graphite (Fe: 3.0 wt %), or Co-containing graphite (Co: 3.0 wt %) may be available as a material for cathode 502 as a material for forming an electron emission material containing the carbon nano-tube, nano-capsule, fullerene or mixture thereof or an electron emission material containing carbon particles on the surface of which at least one of the carbon nano-tube, nano-capsule and fullerene is grown similarly to the first working embodiment.

Protective resistance 510 and ammeter 509 for detecting electric current flowing at the time of arc discharge are placed outside chamber 501 via insulating member 507, and magnet 508 which restricts the region where arc discharge is generated within a given range by magnetic field and power source (not illustrated) are provided. And, He is introduced from gas inlet 513, and diaphragm vacuum gauge 511 and autovalve 512 are placed at the side of gas outlet.

First, He is introduced from gas inlet 513 into chamber 501 which is brought to atmosphere of He of pressure of 0.5 Pa, and then arc current of DC 100A is allowed to flow. As a method of generating arc discharge may be used a method of applying DC continuously or intermittently or applying pulse current. Thereby, arc discharge is generated within the region restricted by magnet 508 to heat cathode 502 locally, and materials constituting cathode 502 are scattered, and scattered droplets of fine carbon particles are produced.

Similarly to the description on FIG. 1, carbon aggregates which have been melted once by plasma of high temperature are recrystallized from the melt zone of the surface of the aforementioned cathode materials when they are quenched in ambient atmosphere, a lot of crystal of the carbon nano-tube, nano-capsule or fullerene is grown around carbon or chemical compound of carbon and catalyst metal as a nucleus. When a melted carbon particle of relatively large is scattered, atomic carbon on its surface is quenched, and carbon nano-tube, nano-capsule, fullerene or mixture thereof is grown on the surfaces of the particle to produce carbon particle which is made to adhere to substrate 504 placed in the vicinity of cathode 502.

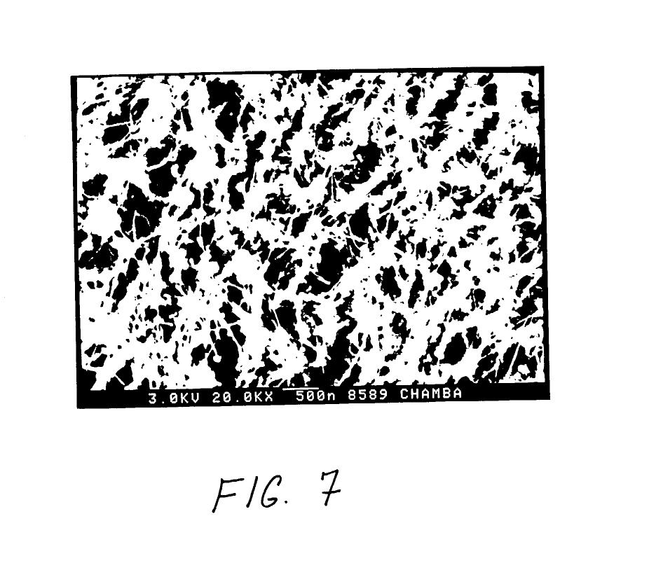

FIG. 6 is a photograph of substrate 504 to which the aforementioned carbon particles are made to adhere under the aforementioned conditions for one minute as film forming time observed by SEM, and FIG. 7 is an enlarged photograph of FIG. 6. The carbon nano-tube looks like a fine line and it is evident that the aforementioned carbon particle are covered with a lot of carbon nano-tube.

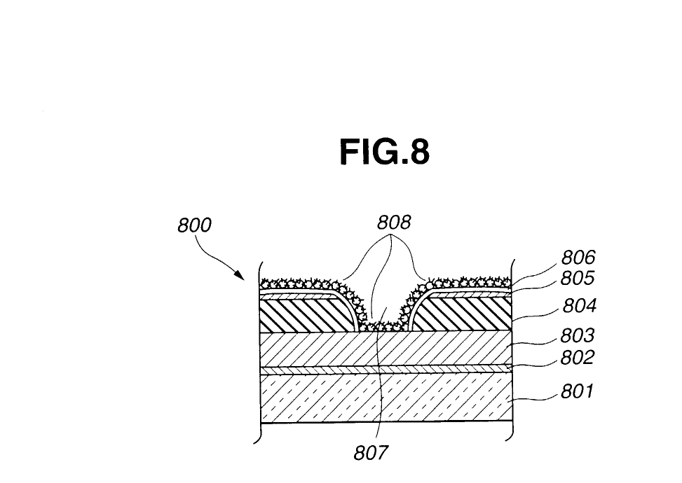

FIG. 8 is a partial sectional view describing a method of preparing an electron emission source using the apparatus shown in FIG. 5. In FIG. 8, electron emission source substrate 800 as a substrate comprises glass-made substrate 801, cathode electrode 802 as the first electrode, resistance layer 803, insulating layer 804, gate electrode 805 as the second electrode, and lift-off film 806 which are laminated to one another, and a hollow is formed so as to expose resistance layer 803.

As substrate 801 may be used a ceramic-made substrate, a semiconductive or conductive substrate and a plastic-made substrate and so on other than the glass-made substrate. It is also possible to control the forming conditions by adding DC bias or RF bias to the substrate.

When the electron emission source is produced, the aforementioned electron emission source substrate 800 is fixed to substrate fixing block 506 in place of substrate 504 and is placed in the vicinity of cathode 502. In this state, arc discharge is generated in such a manner as previously described to produce carbon particles 808 which are made to adhere to electron emission source substrate 800 as shown in FIG. 8.

Thereby, carbon particles are made to adhere to resistance layer 803 and lift-off film 806. An emitter can be formed in which carbon particles 808 are made to adhere only to resistance layer 803 by removing lift-off film 806 in this state to produce the electron emission source similarly to FIG. 4. Also in this case, when resistance layer 803 for prevention of emitter breakdown by excess current is not used, a layer of the carbon nano-tube, nano-capsule or fullerene and fine carbon particles 808 on the surface of which they are grown are made to adhere to cathode electrode 802 directly.

The electron emission source constituted in such a manner as described above emits electrons from the layer of the carbon nano-tube, nano-capsule, fullerene or mixture thereof or from the tip of carbon nano-tube, nano-capsule or fullerene on the surface of the fine carbon particles 808 on the surface of which they are grown by the field emission phenomenon by applying voltage between cathode electrode 802 and gate electrode 806. This can be used for a cathode of a vacuum emission display or vacuum microdevice.

While the present working embodiment is carried out by bring chamber 101 to He atmosphere of 0.5 Pa pressure, it can be carried out in rare gas such as O₂, H₂, N₂ or Ar in an atmosphere of from low vacuum of 10 Torr and below to high vacuum of 10⁻⁶ Torr.

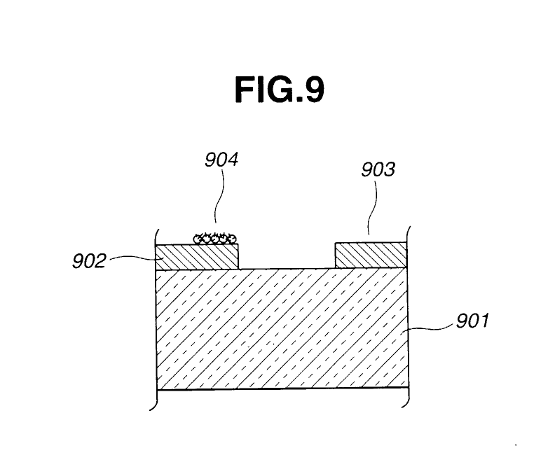

FIG. 9 is a partial side sectional view showing a method of preparing an electron emission source of the third working embodiment of this invention.

In FIG. 9, cathode electrode 902 as the first electrode and gate electrode 903 as the second electrode are made to adhere to glass-made insulating substrate 901 by vapor deposition and so on.

Next, the electron emission source materials produced in the aforementioned first and second working embodiments are made to adhere as emitter 904 on the surface of the upper side of cathode electrode 902 which is situated between the cathode electrode and the gate electrode, thereby producing the electron emission source. It is not, however, objectionable that emitter 904 is made to adhere not on the surface of the upper side of cathode electrode 902 but on the side wall of cathode electrode 902 which is situated between cathode electrode 902 and gate electrode 903.

By applying a given voltage between cathode electrode 902 and gate electrode 903, electrons are emitted from the tip of the carbon nano-tube, nano-capsule or fullerene contained in emitter 904 or from the tip of the carbon nano-tube, nano-capsule or fullerene on the surface of the carbon particles.

The aforementioned working embodiments are characterized in that a forming material comprising graphite or graphite containing a given catalyst metal is heated locally in rare gas such as O₂, H₂, N₂ or Ar in an atmosphere of from given low vacuum of 10 Torr and below to medium and high vacuum of 10⁻³ to 10⁻⁶ Torr to form a thin film of the carbon nano-tube, nano-capsule, fullerene or mixture thereof or fine carbon particles on the surface of which they are grown which is made to adhere to a substrate directly to use an electron emission source element. Thereby, the aforementioned working embodiments do not require several operations such as extraction and purification of carbon nano-tube, nano-capsule or fullerene from the core of cathode deposition of conventional DC arc discharge and so on and is possible to provide a method of preparing an electron emission source on a large scale.

Further, since it has been conventionally required to stabilize the arc discharge by spacing oppositely the cathode and anode in the order of mm apart and applying stable voltage between both of the electrodes, an extremely highly advanced control technique has been required. However, according to each of the aforementioned working embodiments, a thin film of the carbon nano-tube, nano-capsule, fullerene or mixture thereof or fine carbon particle on the surface of which they are grown can be formed on the surface of a given substrate easily and stably for a long period of time by simple control, that is, only by generating arc discharge plasma on the surface of a cathode by a trigger electrode.

Further, according to this invention, a combination of resistance heating, laser heating, lamp heating and so on may be adopted as a sub-heating method in order to heat locally the surface of the aforementioned material such as graphite and so on.

In addition, according to this invention, since the aforementioned carbon nano-tube, nano-capsule, fullerene or mixture thereof or fine carbon particles on the surface of which they are is grown are collected and brought to a state of paste from which the aforementioned emitter can be formed by a printing method, elctrodeposition method, slurry forming method, doctor blade method, sedimentation method, ink-jet method and so on, or by electrostatic adsorption-adhesion in a state of powder, it is possible to provide a method which can produce easily an electron emission source.

Furthermore, according to this invention, a cathode electrode, a resistance layer, an insulating layer, a gate electrode and a lift-off layer are deposited on the aforementioned substrate and a hollow is formed so as to expose the aforementioned resistance layer, the aforementioned lift-off layer is removed after the thin film of the aforementioned carbon nano-tube, nano-capsule, fullerene or mixture thereof or fine carbon particles on the surface of which they are grown are made to adhere to the aforementioned substrate, and a given voltage is applied the cathode electrode and the anode electrode to make it possible to produce an electron emission source which has a function of emitting electrons from the tip of the aforementioned carbon nano-tube, nano-capsule or fullerene or the tip of the carbon nano-tube, nano-capsule or fullerene on the surface of the aforementioned carbon particles. Thereby, an electron emission source can be obtained which has a low threshold limit value and makes emission release of high current density possible.

The electron emission source thus obtained comprises the fine carbon particles on the surface of which a lot of carbon nano-tube, nano-capsule, fullerene or mixture thereof is formed in a state of an urchin. Therefore, when the electron emission source is formed into a cathode substrate, an electron source of low output electric field and high electric density as a field emission electron source can be obtained because the carbon nano-tube which is always directed in the perpendicular direction toward the substrate even if the aforementioned carbon particles are situated in any directions come into existence in high density above fixed ratio. For example, compared with a Spinel-type field emission element, an electron emission is made possible at lower driving voltage, and, simultaneously, high current density can be obtained and production costs can be drastically decreased.

Further, when the electron emission source is produced by the use of the aforementioned carbon particles by means of a screen printing method, ink-jet method, elctrodeposition method, slurry forming method, sedimentation method and so on, there is an advantage that the aforementioned carbon particles can be easily dispersed in solvent and can be easily brought to a state of paste.

Since size of the fine carbon particle on the surface of which the carbon nano-tube, nano-capsule and fullerene are grown is different depending on materials used, density, catalyst metal materials to be added to or mixed with a cathode electrode, plasma forming conditions and cooling solidification conditions, the carbon particles having specific size distribution can be obtained by controlling these conditions properly.

Accordingly, the carbon particles formed under given conditions set are collected and the carbon particles having desired size are further selectively classified, thereby producing proper materials by pastization, electrostatic coating and so on, by which the electron emission source having further excellent electron emission characteristics can be obtained. By application of this, an electric field emission display suitable for high luminescence and large screen display is made possible.

According to this invention, it is made possible to provide a method of preparing an electron emission source at low cost and on a large scale.

Further, according to this invention, it is made possible to provide an electron emission source which is easily produced and which is excellent in electron emission characteristics and easily formed into a large area.

What is claimed is:

1. A method of preparing an emitter of an electron emission source comprising placing as the emitter an electron emission material for emitting an electron between a plurality of electrodes, wherein a particle forming material comprising graphite or graphite containing a given catalyst metal is heated in an atmosphere of a given gas pressure of 10 Torr to 10⁻⁶ Torr to form a carbon particle containing a carbon nano-tube, nano-capsule or fullerene or mixture thereof, said carbon particle being made to adhere onto a substrate.

2. A method of preparing an emitter of an electron emission source comprising placing as the emitter an electron emission material for emitting an electron between a plurality of electrodes, wherein a solid or powdered material comprising graphite or graphite containing a given catalyst metal is heated in plasma in an atmosphere of a given gas pressure of 10 Torr to 10⁻⁶ Torr to form an electron emission material containing a carbon nano-tube, nano-capsule or fullerene or mixture thereof, said electron emission material being made to adhere onto a substrate comprising an insulating material, a semi-conductor or a metal conductive material.

3. A method of preparing an emitter of an electron emission source comprising placing as the emitter an electron emission material for emitting an electron between a plurality of electrodes, wherein a solid or powdered material comprising graphite or graphite containing a given catalyst metal is heated in plasma in an atmosphere of a given gas pressure of 10 Torr to 10⁻⁶ Torr to form an electron emission material containing a carbon particle on the surface of which at least one of a carbon nano-tube, nano-capsule or fullerrene is grown, said electron emission material being made to adhere onto a substrate comprising an insulating material, a semi-conductor or a metal conductive material.

4. A method of preparing an emitter of an electron emission source described in claim 1, characterized in that said catalyst metal is added in said graphite by mixing said catalyst metal with a powdered graphite material or by embedding said catalyst metal in said solid graphite.

5. A method of preparing an emitter of an electron emission source described in claim 2 or 3, characterized in that a vacuum arc discharge method, a vacuum thermal plasma method or a laser abrasion method is used as a method of generating said plasma.

6. A method of preparing an emitter of an electron emission source described in claim 1, characterized in that said electron emission material is produced by making use of a cathode vacuum arc plasma method using a graphite cathode spot in which solid or powdered material comprising graphite or graphite containing a given catalyst metal is used as a cathode, and an inner wall of a container surrounding the cathode serves as an anode.

7. A method of preparing an emitter of an electron emission source described in claim 6, characterized in that said cathode vacuum arc plasma method is that direct current is intermittently applied to an electrode or pulse current is applied to an electrode.

8. A method of preparing an emitter of an electron emission source described in claim 3, characterized in that resistance heating, lamp heating or laser heating is used as a sub-heating method in said plasma.

9. A method of preparing an emitter of an electron emission source described in claim 6, characterized in that a magnetic field is used to control a region of arc plasma as said cathode vacuum arc plasma method.

10. A method of preparing an emitter of an electron emission source described in claim 1, characterized in that said gas is gas or rare gas described by CₓH_{y}O_{z}N_{w} family (X, Y, Z, W≧0).

11. A method of preparing an emitter of an electron emission source described in claim 1, characterized in that said catalyst metal is one selected from the group consisting of Ni, Y, Fe, Co, Pt, Rh, W, V, Pd and mixture thereof.

12. A method of preparing an emitter of an electron emission source described in claim 1, characterized in that direct current bias or RF bias is applied to said substrate.

13. A method of preparing an emitter of an electron emission source described in claim 1, characterized in that said substrate is placed in the vicinity of a forming material for forming said electron emission material and said electron emission material formed is made to adhere directly to said substrate.

14. A method of preparing an emitter of an electron emission source described in claim 13, characterized in that said electron emission material is made to adhere in a state of paste or powder to said substrate to form said emitter.

15. A method of preparing an emitter of an electron emission source described in claim 14, characterized in that a first electrode, an insulating layer, a second electrode and a lift-off layer are deposited to said substrate, and a hollow is formed so as to expose said first electrode, and said lift-off layer is removed after said electron emission material is made to adhere to said substrate.

16. A method of preparing an emitter of an electron emission source described in claim 15, characterized in that a first electrode, a resistance layer, an insulating layer, a second electrode and a lift-off layer are deposited to said substrate, a hollow is formed so as to expose said resistance layer, and said lift-off layer is removed after said electron emission material is made to adhere to said substrate.

17. An emitter for an electron emission source prepared by making use of a method described in claim 1, 2 or 3.

18. An emitter for an electron emission source characterized in that an emitter prepared by a method described in one of claims 1 to 13 is placed between a first electrode and a second electrode which are formed on an insulating substrate, a given voltage is applied between said first electrode and said second electrode to emit an electron from a tip of a carbon nano-tube, nano-capsule or fullerene contained in said emitter, or a tip of a carbon nano-tube, nano-capsule or fullerene on a surface of a carbon particle.
